(19) United States
(12) Patent Application Publication
(10) Pub. No.: US 2015/0117495 A1
(43) Pub. Date: Apr. 30, 2015

(54) Systems and methods for on-chip temperature sensor

(71) Applicant: Maxim Integrated Products, Inc., San Jose, CA (US)

(72) Inventors: Rajesh Tiruvuru, Andhra Pradesh (IN); Krishna Mahesh Karanam, Andhra Pradesh (IN); Ashutosh Joharapurkar, Karnataka (IN); Sung Ung Kwak, Frisco, TX (US)

(21) Appl. No.: 14/171,580

(22) Filed: Feb. 3, 2014

(30) Foreign Application Priority Data
Oct. 29, 2013 (IN) 3413MUM2013

(51) Int. Cl. G01K 7/00; G01K 15/00

(52) U.S. Cl. CPC G01K 7/006; G01K 15/005
USPC 374/178

(57) ABSTRACT

Various embodiments of the invention use the characteristics of BJTs to compute parameter values required to de-embed the effects of non-idealities including BJT's-mismatch in the reverse saturation current and process-dependent injection factor. In some embodiments, a temperature sensor circuit and method provide high temperature accuracy in a low-cost way by individually calibrating each part, thereby, eliminating the need to accurately measure temperature with a precision temperature sensor.

### CROSS-REFERENCE TO RELATED APPLICATIONS

This application claims priority to India Patent Application No. 3413/MUM/2013, filed Oct. 29, 2013, entitled, “Systems and Methods for On-Chip Temperature Sensor,” which application is hereby incorporated herein by reference in its entirety.

### BACKGROUND

A. Technical Field

The present invention relates to low power temperature sensors and, more particularly, to systems, devices, and methods of accurately measuring on-chip temperature with solid-state junction temperature sensors.

B. Background of the Invention

Embedded on-chip temperature sensors are becoming increasingly critical in today's electronic devices. Security and medical device applications, in particular, have stringent requirements for accurate, low-power on-chip temperature monitoring. BJT-based temperature sensors provide extreme low-power solutions. Some existing BJT-based sensors take advantage of the fact that the quantity V_{BE}/ΔV_{BE} of a set of bipolar transistors can be used to measure temperature as the ratio contains all necessary information to extract die temperature.

In these sensors, the ADC is implemented as a two-step converter where a successive-approximation ADC determines the integer portion of V_{BE}/ΔV_{BE} and a sigma-delta ADC determines the fractional portion by digitizing the residue with ΔV_{BE} as its range. Typically, a sigma-delta modulator is used to perform averaging processes that aid in mitigating the effects of non-idealities by techniques such as chopper stabilization and dynamic element matching that reduce offsets and ratio errors, respectively.

However, when compensating error amplifier offset, current mirroring ratio error, and finite beta effects in the analog domain, additional non-idealities are associated with temperature sensing, including but may not be limited to mismatch in the reverse saturation currents of the two BJT's and process-dependent injection factor errors. The mismatch in the reverse saturation currents of the BJT's is oftentimes compensated using continuous switching of the BJT's which may not be power efficient, while process-dependent injection factor errors are corrected incompletely using a batch calibration method that results in a rather non-optimal accuracy. Batch calibration additionally requires a precision temperature sensor of known accuracy, which not only increases cost but also testing time due to the additional time required for the junction temperature to settle.

What is needed are tools to overcome the above-described limitations.

### SUMMARY OF THE INVENTION

The disclosed systems and methods allow to reduce temperature measurement errors in a class of on-chip temperature sensors that are primarily caused by two BJT non-idealities; first, mismatch in the reverse saturation current and, second, process-dependent injection factor error.

In particular, certain embodiments of the invention allow to reduce the effects of mismatch in the reverse saturation currents of BJT's at the time of testing by using a circuit that digitally processes V_{BE} signals generated in the analog domain. In certain embodiments, the circuit reverses the inputs of the BJTs, e.g., via a cross-connecting switch in order to perform an averaging technique.

In certain embodiment a spread in V_{BE} is made predominantly dependent on the spread in the reverse saturation current by trimming the spread in the collector current generating resistor. In some embodiments, a β_{F}-compensation resistor is adjusted proportionally to a biasing resistor in order to avoid introducing new errors or increasing existing errors.

Various embodiments allow to reduce the effects of a process-dependent injection factor by individually calibrating a biasing resistor. In some embodiments, calibration parameters of samples are individually computed at particular test temperatures, thereby, eliminating the need to accurately measure temperature with a precision temperature sensor. The computed parameters are used to de-embed the effects of the non-idealities while taking advantage of known variations in the injection factor with process.

Certain features and advantages of the present invention have been generally described here; however, additional features, advantages, and embodiments presented herein will be apparent to one of ordinary skill in the art in view of the drawings, specification, and claims hereof. Accordingly, it should be understood that the scope of the invention is not limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that this is not intended to limit the scope of the invention to these particular embodiments.

FIG. 1 shows a prior art temperature sensor circuit.

FIG. 2 illustrates a simulated injection factor for a vertical NPN device in 0.18 meter technology.

FIG. 3 is a simulation of the effect of the injection factor in FIG. 2 on measured temperature.

FIG. 4 is a schematic of an illustrative temperature sensor circuit according to various embodiments of the invention.

FIG. 5 is an alternative schematic of an illustrative temperature sensor circuit according to various embodiments of the invention.

FIG. 6A shows an exemplary ideal, actual, and estimated ideal difference voltage characteristic according to various embodiments of the invention.

FIG. 6B illustrates the effect of iterative correction of an injection factor shown in FIG. 3, according to various embodiments of the invention.

FIG. 7A-7B is a flowchart of an illustrative process for accurately determining die temperature in accordance with various embodiments of the invention.

### DETAILED DESCRIPTION OF THE PREFERRED EMBODIMENTS

In the following description, for the purpose of explanation, specific details are set forth in order to provide an understanding of the invention. It will be apparent, however, to one skilled in the art that the invention can be practiced without these details. One skilled in the art will recognize that embodiments of the present invention, described below, may be performed in a variety of ways and using a variety of means. Those skilled in the art will also recognize that additional modifications, applications, and embodiments are within the scope thereof, as are additional fields in which the invention may provide utility. Accordingly, the embodiments described below are illustrative of specific embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. The appearance of the phrase “in one embodiment,” “in an embodiment,” or the like in various places in the specification are not necessarily referring to the same embodiment.

Furthermore, connections between components or between method steps in the figures are not restricted to connections that are affected directly. Instead, connections illustrated in the figures between components or method steps may be modified or otherwise changed through the addition thereto of intermediary components or method steps, without departing from the teachings of the present invention.

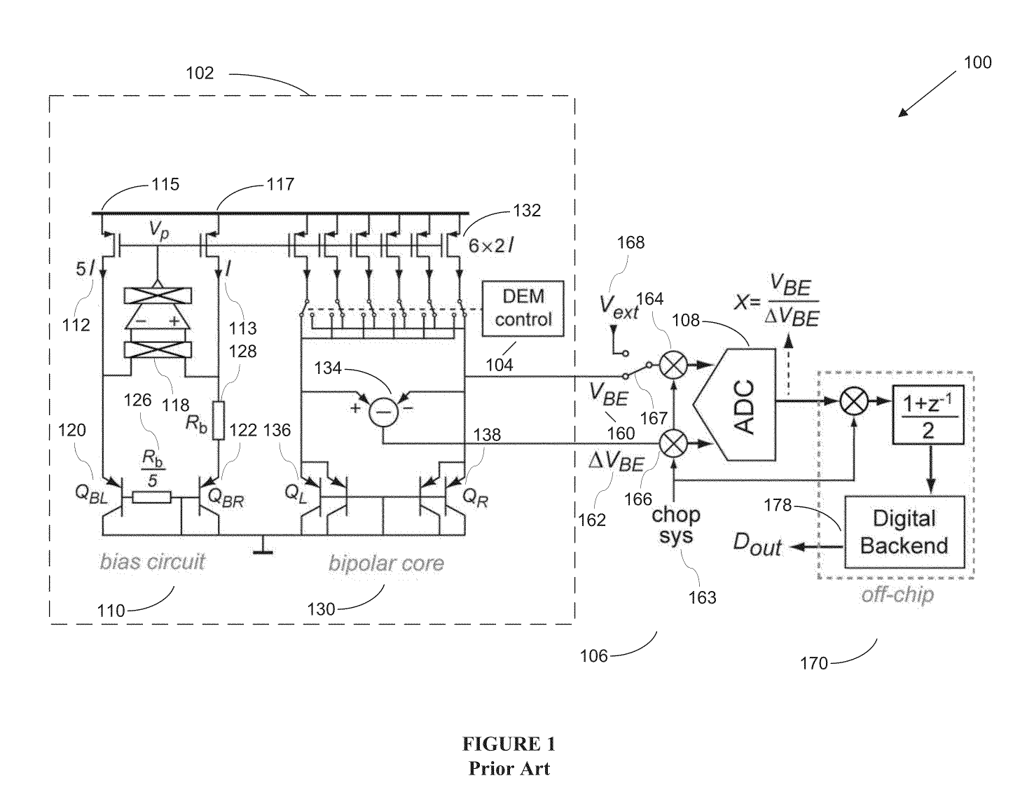

FIG. 1 shows a prior art temperature sensor circuit. Circuit 100 comprises analog front-end 102, DEM control module 104, ADC stage 106, and digital back-end stage 170. Analog front-end 102 consists of bias circuit 110 and bipolar core 130. Bias circuit 110 comprises operational amplifier 118 and two auxiliary PNP transistors 120, 122. Operational amplifier 118 is a low power, self-biased, chopped operational amplifier.

The emitter of auxiliary transistor Q_{BL} 120 is coupled to a voltage supply (not shown) via transistor 115, while the emitter of transistor Q_{BR} 122 is coupled to the voltage supply via transistor 117 and biasing resistor 128. The base of Q_{BR} 122 is directly coupled to ground, while the base of Q_{BL} 120 is coupled to ground via β_{F}-compensation resistor 126. Auxiliary transistor Q_{BL} 120 and Q_{BR} 122 in FIG. 1 are BJT devices, and transistor 115 and 117 are MOSFET devices.

Bipolar core 130 comprises current sources 132, transistors Q_{R} 136 and Q_{L} 138, and summer element 134. Transistors Q_{R} 136 and Q_{L} 138 are identical substrate bipolar transistors that are biased at a 1:5 current ratio. The emitter of transistor Q_{R} 136 and Q_{L} 138 is coupled to the voltage supply via transistor 132. The emitter of transistor Q_{R} 136 and Q_{L} 138 is further coupled to summer element 134. Summer 134 generates difference voltage ΔV_{BE} 162 from the base-emitter voltages of Q_{R} 136 and Q_{L} 138 and outputs this difference voltage to ADC stage 106 for further processing.

ADC stage 106 comprises chop system 163, 164, 166 and ADC 108. ADC 108 is an on-chip ADC that receives voltage ΔV_{BE} 162 and, selectively, voltage V_{BE} 160 or voltage V_{EXT} 168 from chop system 164 and 166, respectively. ADC 108 generates digitized signal 412 that is proportional to the ratio of V_{BE}/ΔV_{BE}, which is output form ADC stage 106 as a digital output signal. In this example, auxiliary transistor Q_{BL} 120 and Q_{BR} 122 are BJT devices with a fixed current ratio of 5, as is determined by a corresponding drain current ratio of MOSFET transistors 115 and 117.

In operation, bias circuit 110 generates, via operational amplifier 118, a PTAT current I 113 and a relatively higher current 112, here 5·I. Since the emitters of Q_{BL} 120 and Q_{BR} 122, which are inputs to amplifier 114, 122, are at the same potential, current 113, 115 is controlled by the difference ΔV_{BE} between the base-emitter voltages of Q_{BL} 120 and Q_{BR} 122. Typically, biasing resistor 126 has a value of R/p, where p is the ratio of currents 113 and 112. Biasing resistor 126 serves to eliminate the forward current gain dependency of the collector currents and V_{BE}. As a result of this β_{F}-compensation, the presence of biasing resistor 126 ensures that process spread dependent gain does not affect collector currents 112 and 113 of Q_{R} 136 and Q_{L} 138, such that V_{BE} 160 is not affected by process spread either.

Current sources 132 and bipolar transistors Q_{R} 136 and Q_{L} 138 are dynamically matched to maintain an average 1:5 current ratio to generate an accurate value ΔV_{BE} 162, such that the difference between the bias-emitter voltages are proportional-to-absolute temperature, PTAT, while V_{BE} 160 is complementary-to-absolute temperature (CTAT). Since the dominant source of sensor inaccuracy, i.e., the spread in ΔV_{BE} 162, is PTAT in nature, a digital PTAT trim is carried out within digital backend 178.

By applying DEM to current sources 132 and Q_{L} 136 and Q_{R} 138, the collector current ratio p and, thus, ΔV_{BE} 162 are made robust to mismatch. The process-dependent non-ideality factor n is extracted by a batch calibration method. The die temperature can then be determined by the following procedure. First, V_{BE} 160 is replaced by external voltage V_{EXT} 168. ADC 108 then digitizes the ratio X_{EXT}=V_{EXT}/ΔV_{BE} from which the actual die temperature T_{D} can be calculated using the following equations:

$$Δ {V}_{BE} = n \cdot \frac{k {T}_{D}}{q} \cdot ln ( p ) , \\ {X}_{EXT} = \frac{{V}_{EXT}}{Δ {V}_{BE}} \\ = > {T}_{D} = \frac{{V}_{EXT}}{{C}_{m} \cdot {X}_{EXT}} , \\ {C}_{m} = n \cdot \frac{k}{q} \cdot ln ( p )$$

where k is the Boltzmann constant, q is the electron charge, T_{D} is the temperature in Kelvin, and p is the collector current ratio. In a second step, V_{EXT} is replaced by the on-chip V_{BE} 160 and a conversion is performed to determine X=V_{BE}/ΔV_{BE} and, hence, the sensor's untrimmed output.

However, the process-dependent non-ideality factor n that is extracted by the batch calibration method is affected by variations caused by the manufacturing process of the device, such as lot-to-lot variations resulting in variations in area, doping level, etc. despite tight process specifications. This causes a systematic error that is much larger than the error resulting from random variations at the microscopic level. In particular, the injection factor, n, appears as a coefficient of the temperature, T_{D}, and is proportional-to-absolute temperature (PTAT) quantity:

$$Δ {V}_{BE} = n {V}_{t} ln ( p ) = ( nT ) \frac{K}{q} ln ( p )$$

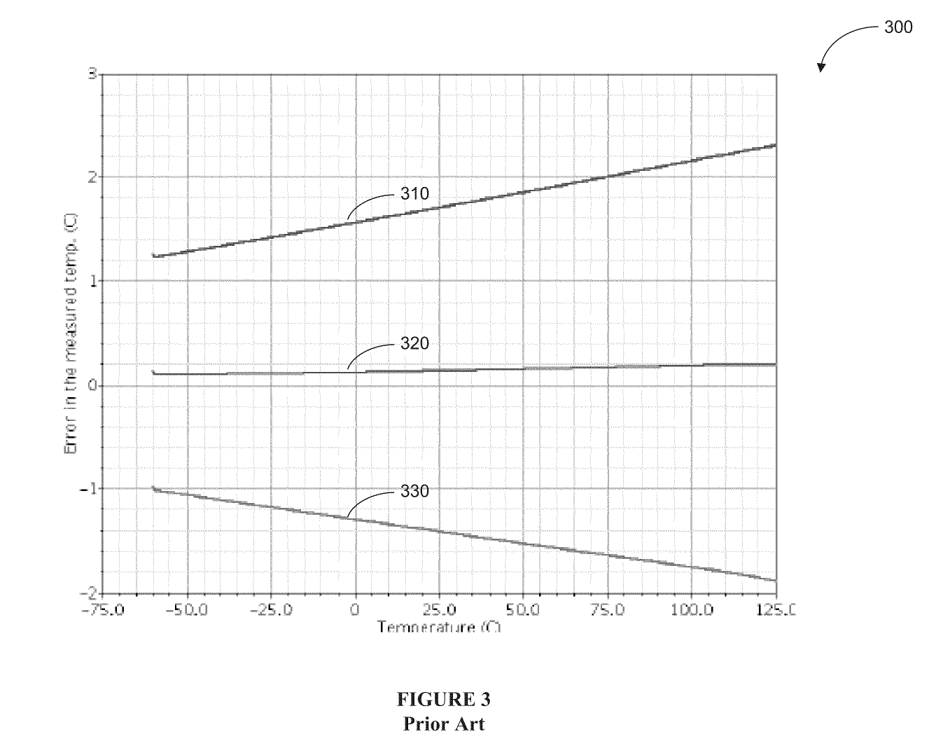

which, if uncompensated modifies the measured temperature, as will be explained with reference to FIG. 3. Therefore, it would be desirable to have systems and methods that deliver accurate sensor data without requiring an alternate accurate temperature sensor and without introducing additional die temperature settling times for any device within a given batch.

The collector current, I_{C}, in a bipolar transistor is typically modeled as:

$${I}_{C} = {I}_{S} exp ( \frac{{V}_{BE}}{n {V}_{t}} )$$

wherein n is the emitter-current injection factor. For an ideal BJT, this quantity is equal to one. Typically, as long as the transistor is biased in an appropriate region of operation, the value of the injection factor remains relatively close to one and does not significantly affect the accuracy of the measured temperature. Even if the value is not equal to one, it is known for a particular point of operation and technology. Some known methods employ a calibration process that first measures the actual die temperature for one part out of a batch of parts with the aid of a precision temperature sensor of known accuracy in order to determine a value for n. Once the actual die temperature is known, on-chip V_{BE} 160 is replaced by known external voltage V_{EXT} 168 and ΔV_{BE} 162 for the part is computed from:

$$Δ {V}_{BE} = \frac{{V}_{BE , ext}}{X}$$

where the X is output of ADC 108. Knowing ΔV_{BE} 162, the die temperature, and design parameter p, the value of n can be computed using the following expression:

ΔV_{BE}=nVₜ ln(p)

In practice, the determination of n is a rather complex and time-consuming undertaking. Therefore, typically n is measured only for a single sample within a batch and it is assumed that all other parts in the batch have the same n value, based on the assumption that all other parents have suffered the same level of process variations as the sample. As a result, the accuracy of existing methods is limited by the extent of process variations within any given batch.

In addition, existing calibration approaches either fail to take into consideration the mismatch in the reverse saturation currents of Q_{R} 136 and Q_{L} 138 or adopt a rather power-inefficient dynamic element matching method. Any ignored mismatch negatively impacts accuracy since a variation in p is equivalent to a variation in n according to the following expression:

$$Δ {V}_{BE} = ( mn ) {V}_{t} ln ( p ) , \\ where m = \frac{ln ( {p}^{′} )}{ln ( p )}$$

where p′ is defined as p·(I_{S1}/I_{S2}), and where p is set at 5 by the dynamic element matched current mirror.

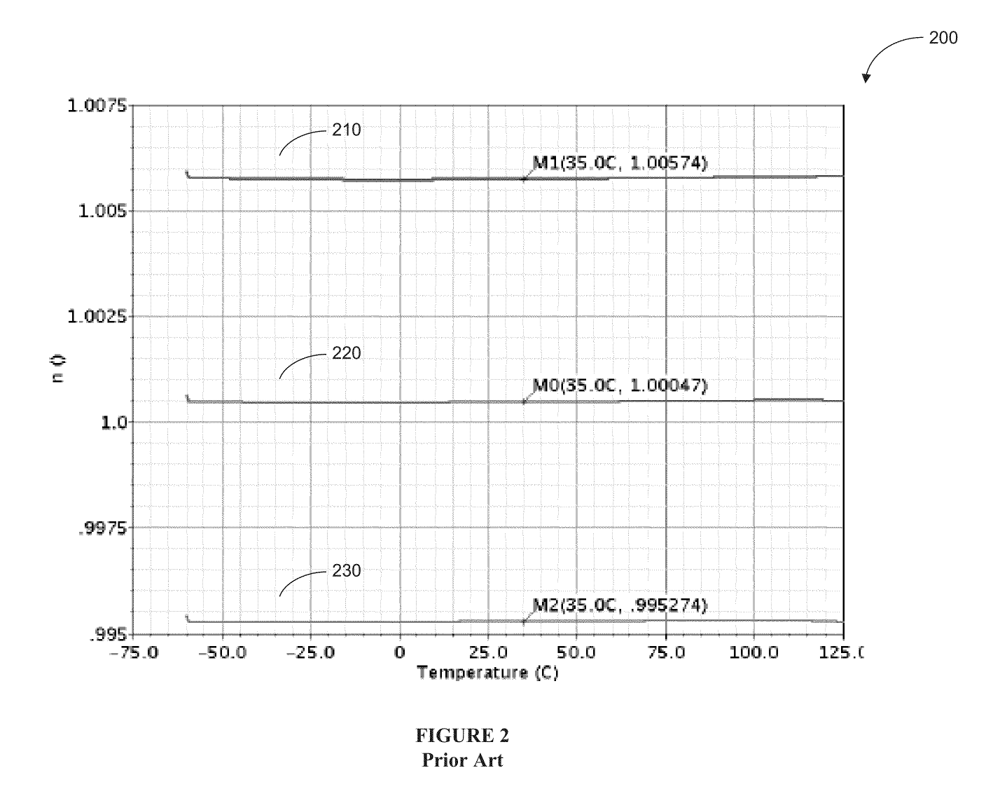

FIG. 2 illustrates a simulated variation of the injection factor for a vertical NPN device in 0.18 μmeter technology. Graph 200 depicts two simulated worst-case scenarios of an uncompensated injection factor for the NPN device as a function of temperature. Plot 210 represents a slow BJT with a relatively small basing resistor. Conversely, plot 230 represents a fast BJT with a relatively large basing resistor. Both scenarios result in a deviation from the typical process that is represented by plot 220. As shown in FIG. 2, the injection factor, n, has a rather insignificant dependency on temperature T.

FIG. 3 is a simulation of the effect of the injection factor in FIG. 2 on measured temperature. The x-axis of graph 300 represents a die temperature, and the y-axis represents the temperature error in degrees Celsius as measured by the temperature sensor. Depicted are three function plots 310-330 for the three values of the injection factor n shown in simulation in FIG. 2.

As shown in FIG. 3, a non-ideal value of the injection factor causes an error in the measured temperature. Since the injection factor is related to a spread in V_{BE} that is caused by process variations, a concern arises that the dependence of n on the spread of V_{BE} is different for reverse saturation current variations than it is for collector current variations caused by a spread in resistor values.

Therefore, in order to increase the accuracy, it would be desirable to eliminate the effect of the collector current in a manner such that the reverse saturation current spread is the only source of the spread in V_{BE} values.

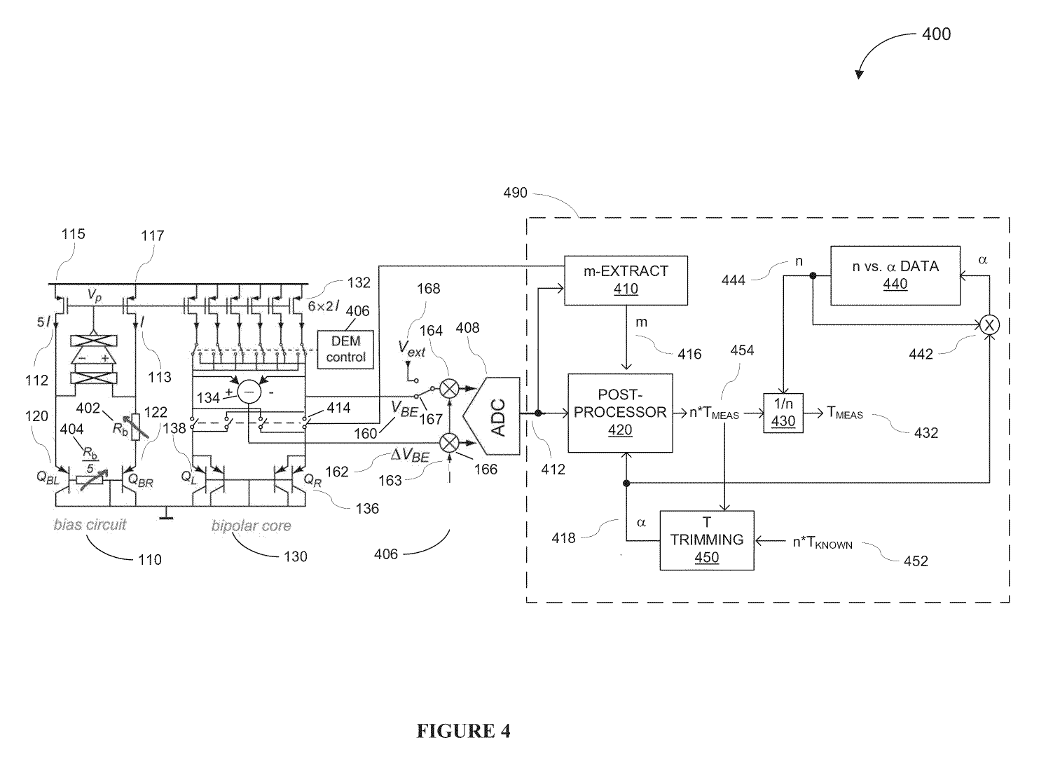

FIG. 4 is a schematic of an illustrative temperature sensor circuit according to various embodiments of the invention. Same numerals as in FIG. 1 denote similar elements. Circuit 400 comprises analog front-end 102, DEM control 406, ADC stage 408, and digital back-end 490. The emitter of auxiliary transistor Q_{BR} 122 is coupled to transistor 117 via biasing resistor 402. The base of transistor Q_{BR} 122 is coupled to the base of transistor Q_{BL} 120 via β_{F}-compensation resistor 404.

ADC 408 within ADC stage 406 may be an offset compensated ADC, such that chopping system 163, 164, and 166 may be eliminated. Digital back-end 490 comprises m-extract module 410, post-processor 420, divider module 430, data module 440, and trimming module 450. Data module 440 represents data or functions that may be obtained cost-effectively, for example, by characterizing a number of devices in a lab environment using a reference temperature sensor. Post-processor 420 receives signal 412 from ADC 108, signal 416 from m-extract module 410, and signal 418 from temperature trimming module 450 and generates modified die temperature signal 454, which is divided by divider 430 to output die temperature 432. Trimming module 450 receives modified die temperature signals 452 and 454 to generate signal 418.

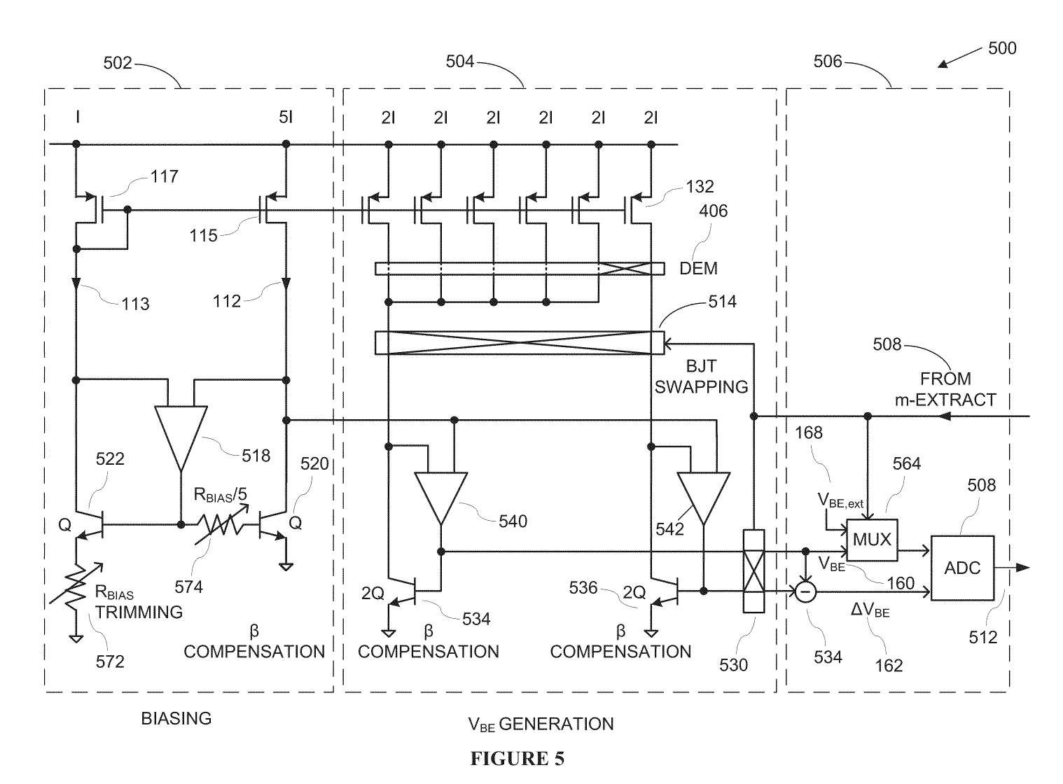

In example in FIG. 4, transistors 120, 122, 138, and 136 are implemented as pnp-type BJTs. One of skill in the art will appreciate that analogous implementations with npn-type transistors are equally possible, as is illustrated in FIG. 5. Prior to operation, biasing resistor 402 is adjusted to compensate for variations in resistance value. This reduces the effect of process spread and may be accomplished by measuring the resistance value and shorting portions of the resistor with switches so as to achieve a specific resistance value. The adjustment of resistor 402 may be performed outside of its circuit 400.

In one embodiment, in order to avoid that adjustments of resistor 402 introduce or increase errors (e.g., related to finite current gain), resistor 404 is adjusted proportionally to biasing resistor Rb 402. Resistor 404 may be independently measured and then adjusted based on adjustments made to resistor Rb 402, thereby, taking advantage of the fact that both resistors are matched. It is noted that β_{F}-compensation may be performed by any other method known in the art or not be performed at all in instances, for example, where Q_{BL} 120 and Q_{BR} 122 already have sufficiently high current gain. Note that Rb is not adjusted (during operation) to adjust bias current (but rather as a pre-calibration and for a different purpose). This step corrects for variations in the collector currents of transistors 120 and 122.

In operation, reference voltage V_{EXT} 168 is supplied to ADC 408 via multiplexer 164 to generate an output signal X. Then, in one embodiment, the inputs of Q_{BL} 136 and Q_{BR} 138 are reversed, for example with a cross switch, to generate an output signal X′ (not shown in FIG. 4). Output signals X and X′ are input to m-extract module 410, which first estimates an voltage difference signal ΔV_{BE} that is idealized with respect to mismatch by summing ΔV_{BE}/2 and ΔV′_{BE}/2. This operation is equivalent to averaging ΔV_{BE} and ΔV′_{BE} using the first and second signals according to the following relationship:

$$Δ {V}_{BE , Ideal , estimated} = \frac{Δ {V}_{BE} + Δ {V}_{BE}^{′}}{2} = \frac{{V}_{BE , ext}}{2 X} + \frac{{V}_{BE , ext}}{2 {X}^{′}}$$

From this estimate, m-extract module 410 generates mismatch signal m according to the expression:

m=ΔV_{BE}/ΔV_{BE,ideal,estimated}

wherein m represents the mismatch in the reverse saturation currents of Q_{L} 136 and Q_{R} 138. In one embodiment, knowing the value of m, the value of p′ is computed from p′=exp(m·ln(p)), and the value of p is updated to p′, such that the effect of mismatch in the reverse saturation currents is corrected.

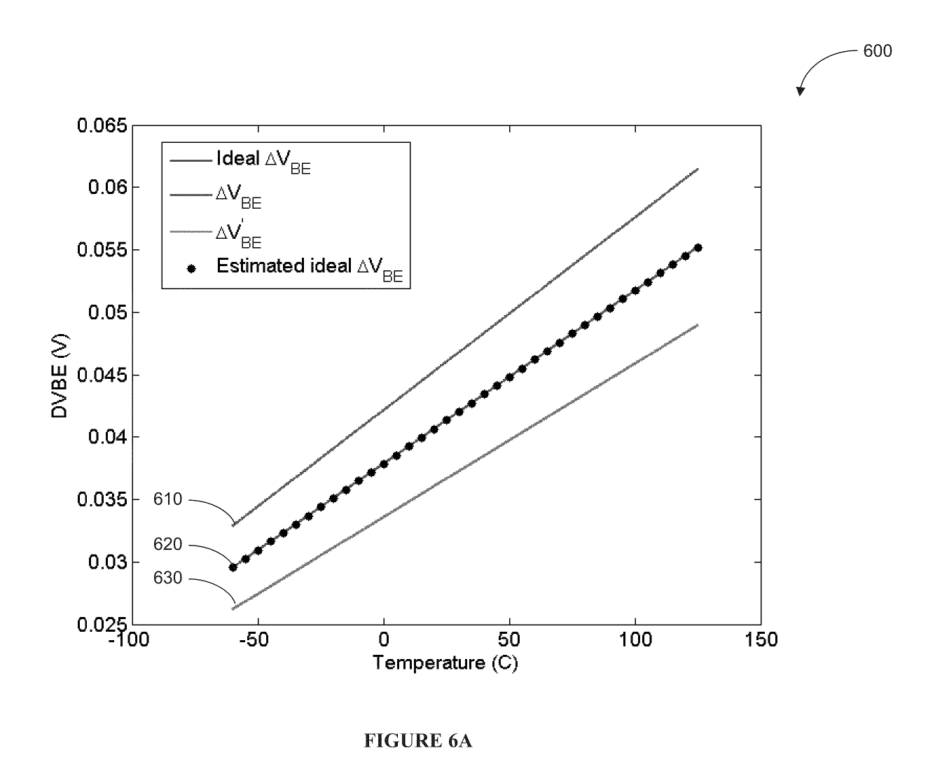

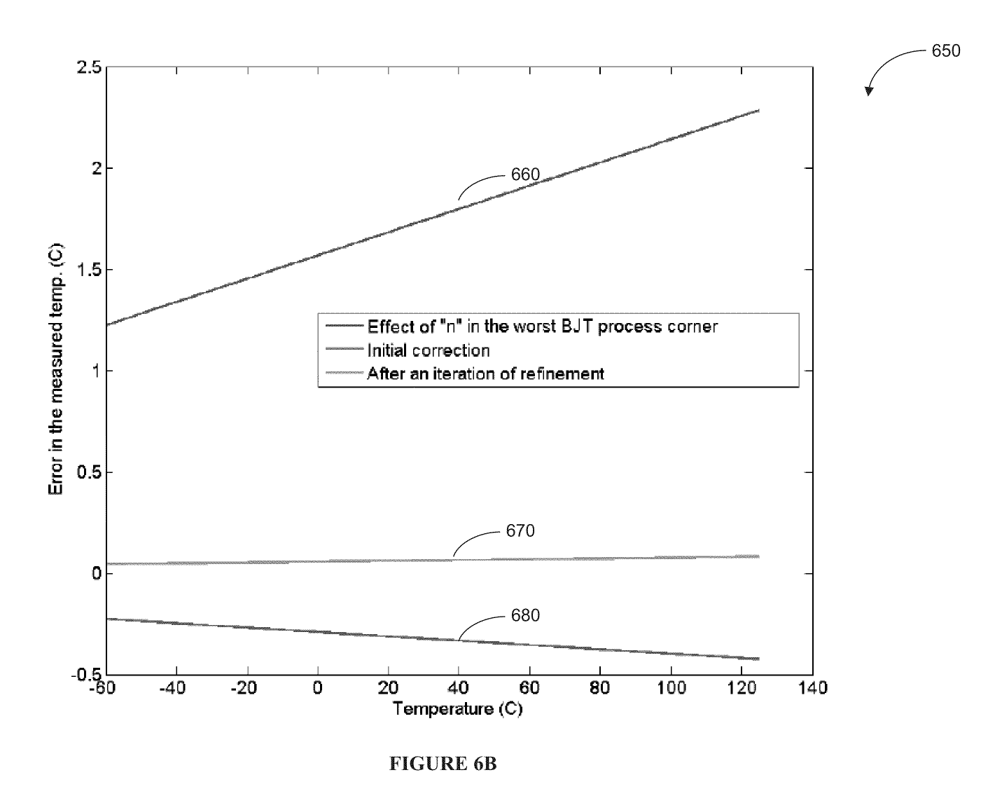

FIG. 6A shows an exemplary ideal, actual, and estimated ideal difference voltage characteristic according to various embodiments of the invention. Graph 600 illustrates how close the estimated ideal difference voltage, ΔV_{BE, ideal, estimated}, is to ΔV_{BE,ideal} together with ΔV_{BE} 162 and ΔV_{BE} for a 20% mismatch in the reverse saturation currents of Q_{L} 136 and Q_{R} 138. The value of m is about 1.113 in this example.

Returning to FIG. 4, after the effect of mismatch in the reverse saturation current of the BJT's is compensated, we compensate for n. First, the die temperature is estimated (without using a reference temperature sensor) by first supplying reference voltage signal V_{BE, ext} 168 to ADC 408 via switch 167. Note that the quantity nT_{known} is referred to herein as modified die temperature, indicating that the effect of n has not been removed yet, i.e., the estimated temperature still has the effect of n. Assuming that the modified die temperature is the die temperature in degree Kelvin, it can be calculated from the expression:

$${nT}_{known} = \frac{Δ {V}_{BE}}{\frac{K}{q} ln ( p )} = \frac{\frac{{V}_{BE , ext}}{X}}{\frac{K}{q} ln ( p )}$$

where X is given by the output of ADC 408.

Then signal V_{BE} 160 is input to ADC 408 and the value α is adjusted in a manner such that the measured modified die temperature n·T_{MEAS} is set to the modified die temperature n·T_{KNOWN}, where the measured modified die temperature is n·T_{MEAS}=A·μ and where A and μ can be obtained from the following expressions:

$$A = \frac{{V}_{BG , ideal}}{\frac{K}{q} ln ( p )}$$

$$μ = \frac{1}{X + α}$$

Rewriting the expression for the measured die temperature yields:

$$n \cdot {T}_{MEAS} = \frac{{V}_{BG , ideal} \cdot n \cdot {T}_{KNOWN}}{{V}_{BE} + δ {V}_{BE} + α \cdot n \cdot {V}_{t} \cdot ln ( p )} ,$$

In other words, the denominator is adjusted to match V_{BG, ideal}. Therefore, by knowing the modified die temperature, the value of coefficient α can be adjusted so as to make match the measured modified die temperature n·T_{MEAS} to the modified die temperature nT_{known}. As a result, the temperature reported by the sensor is now affected primarily by the quantity n.

In order to compensate for the effect of n, in one embodiment, the value of the adjusted constant coefficient α is used to determine the value of n based on n vs. α data 440. The value of n may be plotted against α for a number of samples during characterization by employing a reference temperature sensor, and the obtained information can be used on the production floor. This is made possible due to the relationship between coefficient α and the injection factor n as a result of the set-up.

In one embodiment, the values for α and n are iteratively refined by using the available value of n to calculate a weighing factor α_{new}=α·n, wherein the factor α_{new} represents the spread in V_{BE}, in order to select a new n from n vs. α data 440. The iterations effectively de-embed the injection factor n from the coefficient α.

After the process is complete, divider 430 divides n·T_{MEAS} by n (i.e., T_{MEAS}=A·μ/n) in order to measure the actual die temperature.

FIG. 6B illustrates the effect of iterative correction of an injection factor shown in FIG. 3, according to various embodiments of the invention. FIG. 6B shows simulation results that illustrate that a single iteration may be sufficient to correct for the effects of the injection factor n. It is noted, however, that depending on the implementation, more iterations may be used to refine both α and n. It is also noted that, in this example, the refined quantity α_{NEW} is used only to correct for the value of n rather than to determine a modified temperature.

FIG. 5 is an alternative schematic of an illustrative temperature sensor circuit according to various embodiments of the invention. For clarity, components similar to those shown in FIG. 4 are labeled in the same manner. For purposes of brevity, a description or their function is not repeated here. Circuit 500 comprises biasing module 502, V_{BE} generation module 504, ADC stage 506, and a digital back-end (as was shown in FIG. 4). The emitter of auxiliary transistor 522 in FIG. 5 is coupled gourd via trimming resistor 572. The base of transistor 522 is coupled to the base of transistor 520 via β_{F}-compensation resistor 574. The base of transistor 520, 522 is coupled to the output of operational amplifier 518, while the inputs of operational amplifier 518 are coupled to the collectors of transistor 520 and 522, respectively.

As shown in FIG. 5, one input terminal of operational amplifier 540, 542 is coupled to the collector of transistor 520, the other input terminal is coupled to the collector of transistor 534 and 536, respectively.

In a manner similar to FIG. 4, ADC stage 506 comprises multiplexer 564 and ADC 508. ADC 508 receives voltage ΔV_{BE} 162 and, selectively, voltage V_{BE} 160 or voltage Vₑₓₜ 168 from multiplexer 564. ADC 508 generates digitized signal 512.

In operation, biasing resistor 572 is adjusted to compensate for variations in its resistance value, and β_{F}-compensation resistor 574 may be adjusted accordingly. Operational amplifier 518 ensures that transistors 520 and 522 together with 572 and 574 generate PTAT current 113. By using a Brokaw architecture for the bias in FIG. 5, the offset of operational amplifier 518 has no first order effect on the PTAT bias current. The finite β effect of transistors 520 and 522 on V_{BE} 160 is mitigated by resistor 574. In addition, any mismatch in the β of transistors 534, 536 that has an effect on ΔV_{BE} 162 is removed by the use of amplifiers 540 and 542.

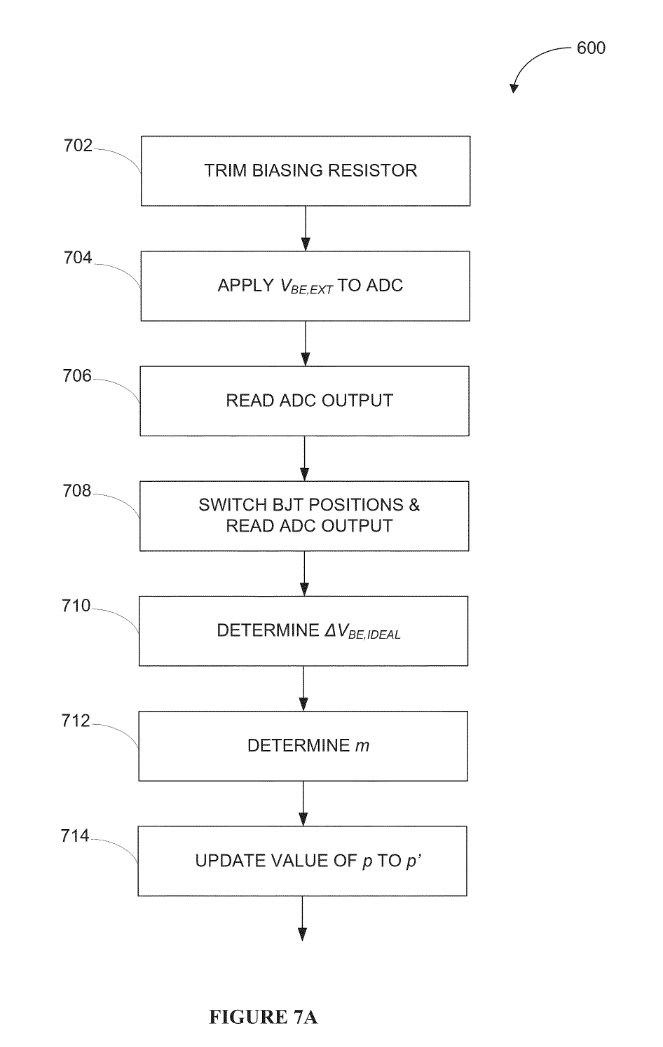

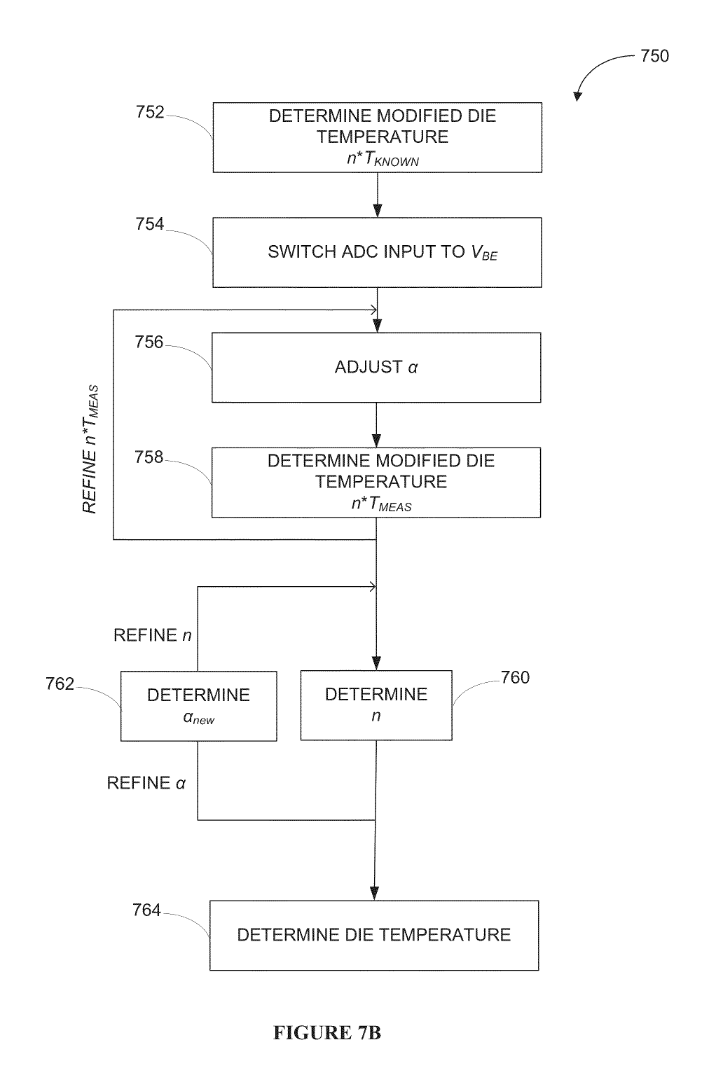

FIG. 7A-7B is a flowchart of an illustrative process for accurately determining die temperature in accordance with various embodiments of the invention. The process for accurately determining die temperature starts at step 702 when the resistance value of a biasing resistor is adjusted in order to reduce process-related spread. As a result, variations in the collector currents of two or more BJTs may be corrected.

At step 704, an external supply voltage is applied to the input terminals of an ADC.

At step 706, the output of the ADC is read out.

At step 708, the position of BJTs is switched, and the output of the ADC is read out again.

At step 710, ideal difference voltage is, created, for example, from the expression ΔV_{BE, ideal}=V_{BE, ext}/(2X)+V_{BE, ext}/(2X′).

At step 712, m is determined, for example, from the expression m=ΔV_{BE}/ΔV_{BE, ideal}.

At step 714, the value of p is updated to the value of p′ to correct the effect of mismatch.

At step 752, the modified die temperature, nT_{known}, is determined, for example, from the expression nT_{known}=V_{BE, ext}/(X·(K/q) ln(p)).

At step 754, an internal voltage, V_{BE}, is applied to the input terminals of the ADC.

At step 756, a value α is adjusted, for example, such that the modified die temperature nT_{MEAS} can be set to the modified die temperature nT_{known}.

At step 758, the modified die temperature is determined.

At this point, the process may return to step 756 to continue with adjusting the value of α in order to refine the modified die temperature T_{MEAS}.

Alternatively, the process may continue, at step 760, with determining n, for example, by using the value of α form a known BJT characteristic.

At this point, the process may continue either at step 762 with the determining a new a, for example as α_{new}=α·n, where α_{new} better represents the spread in V_{BE}, or at step 764 to directly determine the die temperature, for example, as T_{MEAS}=A·μ/n, which is a quantity that is no longer affected by n.

It will be appreciated by those skilled in the art that fewer or additional steps may be incorporated with the steps illustrated herein without departing from the scope of the invention. No particular order is implied by the arrangement of blocks within the flowchart or the description herein.

It will be further appreciated that the preceding examples and embodiments are exemplary and are for the purposes of clarity and understanding and not limiting to the scope of the present invention. It is intended that all permutations, enhancements, equivalents, combinations, and improvements thereto that are apparent to those skilled in the art, upon a reading of the specification and a study of the drawings, are included within the scope of the present invention. It is therefore intended that the claims include all such modifications, permutations, and equivalents as fall within the true spirit and scope of the present invention.

1. A system to measure on-chip temperature, the system comprising:
an analog front-end comprising a first adjustable bias resistor, the first adjustable bias resistor is adjusted to reduce a first effect of the first adjustable bias resistor on a base-emitter voltage of a first transistor; and
a signal processing module coupled to the analog front-end, the signal processing module is configured to compensate a second effect related to a process-dependent factor.

2. The system according to claim 1, further comprising a second adjustable bias resistor coupled to a second transistor and a third transistor, the second adjustable bias resistor is configured to compensate a third effect of a finite gain in the second and third transistors.

3. The system according to claim 2, wherein the second adjustable bias resistor is coupled between base terminals of the second and third transistors.

4. The system according to claim 2, wherein the second and third transistors are coupled to a first operational amplifier in Brokaw architecture so as to eliminate the need for an offset compensation of the first operational amplifier.

5. The system according to claim 2, further comprising a difference voltage generation circuit that further comprises:
a fourth transistor; and
a transistor swapping circuit coupled to the first and fourth transistors, the transistor swapping circuit is configured to reverse positions of the first and fourth transistors in a calibration phase.

6. The system according to claim 5, further comprising second and third operational amplifiers coupled to respective first and fourth transistors to aid in reducing the third effect of the finite gain and a fourth effect of a finite gain mismatch.

7. The system according to claim 5, wherein the first and fourth transistors are bipolar transistors that are biased at a predetermined current ratio.

8. The system according to claim 5, wherein the signal processing module is configured to extract a fifth effect of a mismatch condition in response to the reversal of the positions of the first and fourth transistors.

9. The system according to claim 1, further comprising a data module configured to store data related to a relationship between the process-dependent factor and a parameter.

10. The system according to claim 9, wherein the signal processing module comprises a trimming module that generates the parameter based on a modified die temperature signal.

11. The system according to claim 10, wherein the generated parameter represents a process variation that is related to the first transistor.

12. The system according to claim 9, wherein the signal processing module is configured to extract the process-dependent factor based on the relationship between the process-dependent factor and the parameter.

13. The system according to claim 1, wherein the signal processing module is implemented in software.

14. A method to measure on-chip temperature comprising:
reducing a first effect related to a mismatch condition related to a reverse saturation current of a transistor, wherein reducing comprises adjusting a resistance value in a compensation resistor;
reducing a second effect related to a process-dependent factor; and
determining a measured temperature.

15. The method according to claim 14, wherein reducing the first effect further comprises:
supplying a reference voltage;
determining a plurality of voltage difference signals; and
determining a mismatch signal from the plurality of voltage difference signals.

16. The method according to claim 15, wherein reducing the second effect comprises:
supplying one of the plurality of voltage difference signals;
adjusting a first parameter in a manner such that the measured temperature equals a known temperature; and
determining the process-dependent factor based on a relationship between the process-dependent factor and the first parameter.

17. The method according to claim 16, wherein determining the relationship between the process-dependent factor and the first parameter and adjusting the resistance value are performed prior to regular circuit operation.

18. A method to measure on-chip temperature comprising:
reducing effects on a base-emitter voltage of a transistor, wherein reducing the effects further comprises:
adjusting a first resistance value to reduce a spread so as to reduce variations in collector currents of two BJTs;
adjusting a second resistance value to perform a beta-compensation;
supplying a reference voltage to a first input of an ADC;
generating a first signal based on the reference voltage;
interchanging the two BJTs;
generating a second signal based on the reference voltage;
determining first and second voltage difference signals from the first and second signals and the reference voltage;
determining a third signal from the first voltage difference signal and the second voltage difference signal;
generating a fourth signal from the third signal; and
updating a fifth signal with the fourth signal; and
adjusting for effects of an emitter-current injection factor, wherein adjusting further comprises:
determining a first temperature that is related to the reference voltage;
adjusting a first parameter in a manner such that a second temperature equals the first temperature; and
determining the emitter-current injection factor from the adjusted first parameter.

19. The method according to claim 18, further comprising determining a second parameter in order to refine the first parameter.

20. The method according to claim 19, further comprising refining the emitter-current injection factor based on the refined first parameter.
